(19) United States
(12) Patent Application Publication
(10) Pub. No.: US 2006/0065018 A1
(43) Pub. Date: Mar. 30, 2006

(54) Mold for molding glass elements

(75) Inventor: Charles Leu, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/225,473

(22) Filed: Sep. 13, 2005

(30) Foreign Application Priority Data
Sep. 24, 2004 (CN) 200410051682.5

(51) Int. Cl. C03B 23/22

(52) U.S. Cl. 65/37; 65/39

(57) ABSTRACT

A mold for molding glass elements includes a substrate (1), a protecting film (2) and a cooling tube (10). The protecting film is formed on the substrate. The protecting film includes at least one noble metal layer (21) and at least one silicon carbide layer (22). The noble metal layer and the silicon carbide layer are alternately stacked one on the other in turn. The cooling tube is arranged in the substrate. The present invention also discloses another mold for molding glass elements including a substrate, a protecting film and a channel. The channel is defined in the substrate. The mold is inexpensive, can withstand high temperatures, and has a long service lifetime.

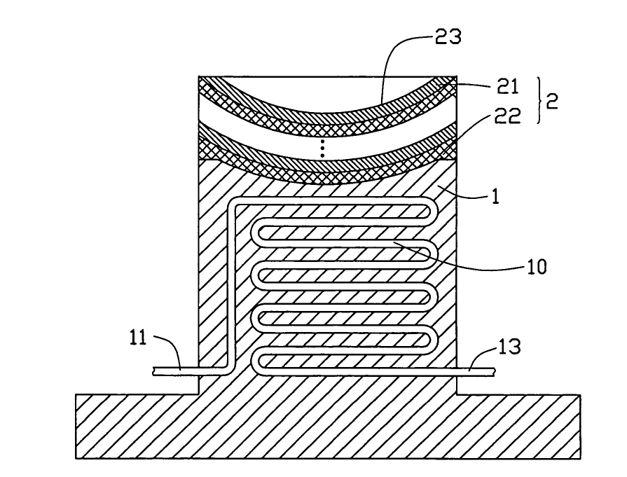

### FIELD OF THE INVENTION

The present invention relates to a mold, and particularly to a mold for molding glass elements such as aspheric lenses which are used in digital devices.

### GENERAL BACKGROUND

With the rapid development of multimedia technology, digital devices such as digital still cameras (“still cameras”) and digital video cameras (“video cameras”) have become epidemic in many countries in recent years. Consumers expect still cameras and video cameras to have a compact size, while still being capable of providing high imaging quality. One of the decisive factors in obtaining high imaging quality for still cameras and video cameras is the optical lenses employed therein.

Aspheric lenses are necessary for many of the above-described digital devices. Aspheric lenses are mostly made by molding. Regarding a mold used for molding glass elements such as aspheric lenses, it is important that: (1) a material of the molding surface has excellent chemical stability, so that the mold does not react with or adhere to the glass material; (2) the molding surface is hard enough not to be damaged by scratching or the like; (3) the mold is strong and does not deform, even at very high temperatures; (4) the mold is highly resistant to heat shock; (5) the machinability of the mold is excellent so as to reduce the machining time and cost; and (6) the service lifetime of the mold is long so as to reduce costs.

A typical mold for molding glass elements comprises a substrate and a protecting film. The substrate can be made of one of stainless steel, silicon carbide (SiC), tungsten carbide (WC), and so on. The protecting film can be made of a diamond like carbon (DLC) material, a noble metal such as platinum (Pt), iridium (Ir) or ruthenium (Ru), or a noble metal alloy mainly including any one or more of platinum (Pt), iridium (Ir), ruthenium (Ru), and so on.

The aforementioned protecting films have some shortcomings. For example, a diamond like carbon film generally has a short service lifetime. This increases costs. In addition, the diamond like carbon film cannot withstand high temperatures, because it is liable to be converted into graphite at about 500° C. or higher. A monolayer noble metal protecting film or a noble metal alloy film generally cannot withstand high temperatures, either. For example, the temperature threshold of a Pt—Ir alloy is about 520° C.˜550° C. High molding temperatures are generally apt to result in thermal etching, whereby the surface of the mold may crack rapidly. In addition, in the case of the noble metal alloy film, it is difficult to remove the molded glass element from the mold. Furthermore, a mold having a noble metal alloy film is unduly expensive. Moreover, a tensile stress generally occurs in a monolayer protecting film. This may cause the protecting film to crack.

What is needed, therefore, is a mold which is inexpensive, which can withstand high temperatures, and which has a long service lifetime.

### SUMMARY

A mold for molding glass elements includes a substrate, a protecting film and a cooling tube. The protecting film is formed on the substrate. The protecting film includes at least one noble metal layer and at least one silicon carbide layer. The noble metal layer and the silicon carbide layer are alternately stacked one on the other in turn. The cooling tube is arranged in the substrate.

Another mold for molding glass elements includes a substrate, a protecting film and a channel. The channel is defined inside the substrate.

Firstly, the mold includes a tube or a channel in the substrate. A kind of coolant flows though the tube or the channel will bring a quantity of heat away from the substrate when molding. Therefore, the substrate can withstand higher temperatures and have a longer service lifetime. Secondly, the multilayer protecting film relieves tensile stress in the protecting film. Thus, it will not form any cracks on the protecting film and glass elements can be released from the mold easily. Thirdly, the protecting film includes silicon carbide besides noble metal, so the cost of the mold is reduced. Fourthly, the substrate which is made of stainless steel has excellent machinability.

Other advantages and novel features will become more apparent from the following detailed description when taken in conjunction with the accompanying drawing, in which:

### BRIEF DESCRIPTION OF THE DRAWING

The drawing is an abbreviated, cross-sectional view of a mold for molding glass elements in accordance with a preferred embodiment of the present invention.

### DETAILED DESCRIPTION OF PREFERRED EMBODIMENTS

Referring to the drawing, this represents a mold for molding glass elements in accordance with a preferred embodiment of the present invention. The mold includes a substrate 1 and a protecting film 2. The protecting film 2 is formed on the substrate 1.

The substrate 1 is made of stainless steel. A tube 10 is embedded in the substrate 1 and is arranged in a zigzag fashion. The tube 10 includes an entrance 11 and an exit 13. When the mold is used to form a glass element, a coolant is introduced into the tube 10 through the entrance 11 and is discharged out of the tube 10 through the exit 13. By doing so, heat in the substrate 1 is effectively dissipated. Thereby, the substrate 1 is cooled down.

The protecting film 2 is a multilayer overcoat formed on the substrate 1. The protecting film 2 includes a plurality of noble metal layers 21 and a plurality of silicon carbide layers 22. The noble metal layers 21 and the silicon carbide layers 22 are alternatively stacked one on the other. The protecting film 2 has a molding surface 23. The uppermost layer of the protecting film 2 is an uppermost noble metal layer 21. The lowermost layer of the protecting film 2 is a lowermost silicon carbide layer 22, which is formed on the substrate 1. The number of noble metal layers 21 and the silicon carbide layers 22 are generally in the range from 5˜300 respectively, and are preferably in the range from 30˜300. A thickness of each noble metal layer 21 is generally in the range from 10˜20 nm (nanometers). Each noble metal layer 21 is made of an iridium (Ir) rhenium (Re) alloy (ReₓIr_{y}), wherein 0.3≦x≦0.7, and 0.3≦y≦0.7. Namely, a proportion by mole of each of iridium and rhenium is at least 30% and no more than 70%. A thickness of each silicon carbide layer 22 is generally in the range from 5˜20 nm.

In an alternative embodiment, the tube 10 may be substituted with a channel defined in the substrate 1, the channel having a configuration similar to that of the tube 10.

It is believed that the embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claim:

1. A mold for molding glass elements, comprising:
a substrate;
a protecting film formed on the substrate, the protecting film comprising at least one noble metal layer and at least one silicon carbide layer; and
a cooling tube arranged in the substrate;
wherein the noble metal layer and the silicon carbide layer are alternately stacked one on another.

2. The mold as claimed in claim 1, wherein an uppermost layer of the protecting film is one noble metal layer, and a lowermost layer of the protecting film is one silicon carbide layer that is formed on the substrate.

3. The mold as claimed in claim 1, wherein the substrate is made of stainless steel, and the tube is arranged in a zigzag fashion in the substrate.

4. The mold as claimed in claim 1, wherein the at least one noble metal layer is a plurality of noble metal layers, the at least one silicon carbide layer is a plurality of silicon carbide layers, and the number of noble metal layers and silicon carbide layers are in the range from 5˜300 respectively.

5. The mold as claimed in claim 1, wherein a thickness of each noble metal layer is in the range from 10˜20 nm.

6. The mold as claimed in claim 1, wherein a thickness of each silicon carbide layer is in the range from 5˜20 mn.

7. The mold as claimed in claim 1, wherein the noble metal layer is made of an iridium-rhenium alloy (ReₓIr_{y}), wherein a proportion by mole of each of iridium and rhenium is at least 30% and not more than 70%.

8. A mold for molding glass elements, comprising:
a substrate;
a protecting film formed on the substrate; and
a channel defined in the substrate.

9. The mold as claimed in claim 8, wherein the protecting film comprises at least one noble metal layer and at least one silicon carbide layer, and the noble metal layer and the silicon carbide layer are alternately stacked one on another.

10. The mold as claimed in claim 9, wherein an uppermost layer of the protecting film is one noble metal layer, and a lowermost layer of the protecting film is one silicon carbide layer that is formed on the substrate.

11. The mold as claimed in claim 8, wherein the substrate is made of stainless steel, and the channel is circuitously defined inside the substrate.

12. The mold as claimed in claim 9, wherein the at least one noble metal layer is a plurality of noble metal layers, the at least one silicon carbide layer is a plurality of silicon carbide layers, and the number of noble metal layers and silicon carbide layers are in the range from 5˜300 respectively.

13. The mold as claimed in claim 9, wherein a thickness of each noble metal layer is in the range from 10˜20 nm.

14. The mold as claimed in claim 9, wherein a thickness of each silicon carbide layer is in the range from 5˜20 nm.

15. The mold as claimed in claim 9, wherein the noble metal layer is made of an iridium-rhenium alloy (ReₓIr_{y}), wherein a proportion by mole of each of iridium and rhenium is at least 30% and no more than 70%.

16. A method to manufacture a mold for glass elements, comprising the steps of:
preparing a substrate of said mold;
forming a layer of a first material having acceptable mold-protecting quality and a layer of a second material capable of effectively attaching said layer of said first material to said substrate so as to stack said layer of said first material with said layer of said second material; and
repeatedly forming and alternately stacking said stacked layers of said first material and said second material more than one time in order to complete a protecting film having said stacked layers of said first material and said second material on said substrate of said mold.

17. The method as claimed in claim 16, wherein said substrate is made of stainless steel with a channel defined therein for cooling use.

18. The method as claimed in claim 16, wherein said first material is one of noble metal including an iridium-rhenium alloy (ReₓIr_{y}), and said second material is silicon carbide.
